(19) United States
(12) Patent Application Publication
(10) Pub. No.: US 2011/0066978 A1
(43) Pub. Date: Mar. 17, 2011

(54) ELECTRONIC APPARATUS AND TOUCH MENU CONTROL METHOD THEREOF

(75) Inventor: Peng-Hsiang Sung, Taipei (TW)

(73) Assignee: COMPAL ELECTRONICS, INC., Taipei City (TW)

(21) Appl. No.: 12/725,445

(22) Filed: Mar. 16, 2010

(30) Foreign Application Priority Data
Sep. 11, 2009 (TW) 98130812

(51) Int. Cl. G06F 3/048; G06F 3/033

(52) U.S. Cl. 715/823; 715/829; 715/810; 715/863

(57) ABSTRACT

An electronic apparatus and a touch menu control method thereof are provided. In the method, when a touch device detects a first touch signal, a menu controlling module is configured to start a menu controlling program to display a touch menu on a display device. The touch menu comprises a plurality of items and each of the items corresponds to a function. When the first touch signal exists, sequentially selecting one of the items every first predetermined time. Moreover, selecting the function corresponding to a currently selected item when the first touch signal is interrupted. Finally, executing a currently selected function according to a second touch signal detected by the touch device.

### CROSS-REFERENCE TO RELATED APPLICATION

This application claims the priority benefit of Taiwan application serial no. 98130812, filed on Sep. 11, 2009. The entirety of the above-mentioned patent application is hereby incorporated by reference herein and made a part of specification.

### BACKGROUND OF THE INVENTION

1. Field of the Invention

The invention generally relates to an electronic apparatus and a control method thereof, and more particularly, to an electronic apparatus and a touch menu control method thereof.

2. Description of Related Art

As technology advances, the popularity of the use of the computer system has greatly increased. Nowadays people have become more and more accustomed in daily life to doing work on a computer system, receiving/sending emails through a computer system, or browsing the web and playing multimedia files through a computer system. With the development of the notebook, portability has been added to the original configuration of the computer system, and now users can enjoy the convenience of a computer system anytime and anywhere.

Generally, in order to make the use of the computer system more convenient, the system manufacturer usually adds a plurality of hotkeys to the notebook during the stage of designing their product. Accordingly, users simply press a hotkey to directly start the corresponding function. However, each of the hotkeys simply corresponds to a single function. Moreover, the corresponding relationship between the hotkey and its function is preset by the system manufacturer before the notebook leaves the factory. Accordingly, the users can not add the hotkeys by themselves, and further, they can not change the function to correspond to the hotkey of their own choice, either.

Obviously, as the processing capacity of the computer system has increased dramatically, quickly starting functions which the users require becomes more and more important. However, for the system manufacturer, it increases the cost of hardware to increase the number of the hotkeys, and it still may not satisfy the requirements of each consumer. For the users, they have to remember the corresponding relationships between each hotkey and its function.

### SUMMARY OF THE INVENTION

Accordingly, an embodiment of the invention provides a touch menu control method to increase the functions supported by a touch device of an electronic apparatus.

An embodiment of the invention provides an electronic apparatus. Users are able set each of the functions supported by a touch device of the electronic apparatus according to the users' habits.

An embodiment of the invention provides a touch menu control method of an electronic apparatus having a touch device and a display device, wherein the touch device is independent of the display device. In this method, displaying a touch menu on the display device when the touch device detects a first touch signal, wherein the touch menu comprises a plurality of items, and each of the items corresponds to a function. While the first touch signal exists, sequentially selecting one of the items every first predetermined time. When the first touch signal is interrupted, selecting the function corresponding to a currently selected item, and executing a currently selected function according to a second touch signal detected by the touch device.

In an embodiment of the invention, after the step of displaying the touch menu on the display device when the touch device detects the first touch signal, the control method further includes a step of selecting one of the items to serve as the currently selected item. In an embodiment, the currently selected item is the item corresponding to the function which was last executed.

In an embodiment of the invention, the step of sequentially selecting one of the items every first predetermined time while the first touch signal exists includes a step of determining whether a first touch signal existing time is longer than the first predetermined time. If the first touch signal existing time is longer than the first predetermined time, selecting the next item in sequence to serve as the currently selected item, and counting the first touch signal existing time again. Next, determining whether the first touch signal exists. If the first touch signal still exists, repeating the above-described steps until the first touch signal is interrupted.

In an embodiment of the invention, after the step of determining whether the first touch signal existing time is longer than the first predetermined time, the step of sequentially selecting one of the items every first predetermined time while the first touch signal exists further includes following steps. If the first touch signal existing time is shorter than the first predetermined time, determining whether the first touch signal still exists. If the first touch signal still exists, determining whether the first touch signal existing time is longer than the first predetermined time again.

In an embodiment of the invention, the step of sequentially selecting one of the items is performed when the first touch signal has lasted for at least a second predetermined time, and the second predetermined period is longer than the first predetermined time.

In an embodiment of the invention, the step of sequentially selecting one of the items every first predetermined time while the first touch signal exists includes a step of marking the currently selected item in the touch menu.

In an embodiment of the invention, the step of executing the currently selected function according to the second touch signal detected by the touch device includes following steps. If the currently selected function is an adjusting function, executing an incremental adjustment on an operation of a hardware device corresponding to the currently selected item according to directionality of the second touch signal; and if the currently selected item corresponds to a starting function, starting a program corresponding to the currently selected item.

In an embodiment of the invention, the step of executing the incremental adjustment on the operation of the hardware device when the currently selected function is the adjusting function includes a step of displaying a degree of the incremental adjustment on the display device.

An embodiment of the invention provides an electronic apparatus. The electronic apparatus includes a display device, a touch device, and a menu controlling module. The touch device configured to detect a first touch signal. The menu controlling module is coupled to the display device and the touch device, and the menu controlling module is configured to start a menu controlling program to display a touch menu on the display device when the touch device detects a first touch signal. The touch menu includes a plurality of items, and each of the items corresponds to a function. While the first touch signal exists, the menu controlling program sequentially selects one of the items every first predetermined time, and when the first touch signal is interrupted, the menu controlling program is configured to select the function corresponding to a currently selected item. Moreover, the menu controlling program is configured to execute a currently selected function when a second touch signal is detected by the touch device.

In an embodiment of the invention, the electronic apparatus further includes an input and output controller (I/O controller) coupled between the touch device and the menu controlling module. The menu controlling program recognizes detection of the first touch signal and the second touch signal by the touch device through the I/O controller.

In an embodiment of the invention, after the menu controlling module starts the menu controlling program to display the touch menu on the display device, the menu controlling program selects one of the items to serve as the currently selected item.

In an embodiment of the invention, when the currently selected function corresponding to the currently selected item is an adjusting function, the menu controlling program informs the I/O controller to execute an incremental adjustment on an operation of a hardware device corresponding to the currently selected item. The I/O controller outputs an adjustment signal to execute the incremental adjustment on the operation of the hardware device corresponding to the currently selected item according to directionality of the second touch signal and a type of the hardware device. Moreover, the I/O controller informs the menu controlling program of a degree of the incremental adjustment, so as to display the degree of adjustment on the display device.

In an embodiment of the invention, when the currently selected function corresponding to the currently selected item is a starting function, the menu controlling program informs the I/O controller to output a starting signal to start a program corresponding to the currently selected item.

In an embodiment of the invention, the menu controlling module further includes a setting interface. The setting interface is configured to add, delete, or modify the items of the touch menu when the setting interface receives an item management signal. Moreover, the setting interface is configured to modify the functions corresponding to the items when the setting interface receives a function management signal, and the setting interface adjusts the first predetermined time and a second predetermined time when the setting interface receives a time management signal.

In an embodiment of the invention, the I/O controller is an embedded controller.

In an embodiment of the invention, the touch device is a capacitive touch device, a resistive touch device, or a mechanical touch device.

In view of the above, an embodiment of the invention provides a touch menu control method to increase the functions supported by a touch device of an electronic apparatus. When the touch device detects the touch signal triggered by the user, the menu controlling module is configured to start a menu controlling program to display a touch menu on the display device. And further, determining whether the touch signal existing time, sequentially selecting and executing one of the items corresponds to a function. When the touch signal exists, sequentially selecting one of the items every first predetermined time. Moreover, selecting the function corresponding to the selected item when the first touch signal is interrupted. Finally, executing the selected function according to a second touch signal detected by the touch device. As a result, the user is able to execute all kinds of functions on the electronic apparatus through the same touch device. Accordingly, the convenience of using the electronic apparatus is increased.

To make the aforementioned and other features and advantages of the invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of an electronic apparatus according to an embodiment consistent with the invention.

FIG. 2 is a flowchart of a touch menu control method according to an embodiment consistent with the invention.

FIG. 3 is a flowchart of execution of a function of adjusting volume of a sound broadcasting device according to an embodiment consistent with the invention.

FIG. 4 is a flowchart of execution of a function of turning on or turning off a network device according to an embodiment consistent with the invention.

FIG. 5 is a flowchart of a touch menu control method according to an embodiment of the invention.

### DESCRIPTION OF EMBODIMENTS

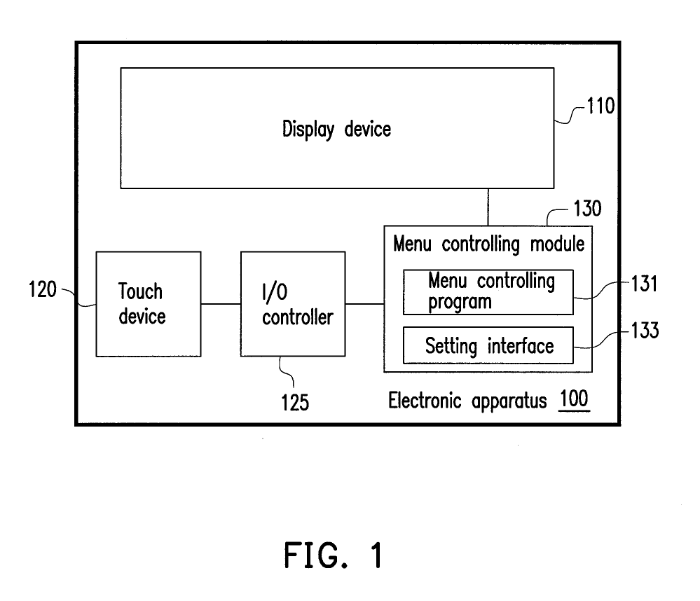

FIG. 1 is a schematic view of an electronic apparatus according to an embodiment consistent with the invention. Referring to FIG. 1, the electronic apparatus 100 includes a display device 110, a touch device 120, an input and output controller (I/O controller) 125, and a menu controlling module 130. The electronic apparatus 100, for example, is a notebook, but the type of the electronic apparatus 100 is not limited herein.

The display device 110, for example, is a liquid crystal display (LCD) configured to display all kinds of operating frames of the electronic apparatus 100. The touch device 120 may be one of the touch sensing apparatuses having different forms, such as a capacitive touch device, a resistive touch device, and a mechanical touch device, and it is not limited thereto. When the user touch the touch device 120 with fingers or input tools, the touch device 120 thus receives the corresponding touch signals. In the present embodiment, the display device 110 and the touch device 120 are independent of each other.

The menu controlling module 130 is connected to the display device 110 and coupled to the touch device 120 through the I/O controller 125. The menu controlling module 130 is configured to provide a menu controlling program 131 and a setting interface 133. When the touch device 120 detects a first touch signal by user's touch, the menu controlling module 130 starts the menu controlling program 131, so as to display a touch menu on the display device 110 by the menu controlling program 131. The touch menu has a plurality of items, and each of the items corresponds to a different function, such as operation adjusting functions of all types of hardware devices of the electronic apparatus 100, and starting functions of programs of the electronic apparatus 100. Next, the menu controlling program 131 sequentially selects one of the items in the touch menu when the user touches the touch device 120 continuously. When the touch device 120 detects that the first touch signal exists, the menu controlling program 131 selects the function corresponding to a currently selected item when the first touch signal is interrupted, and when the touch device 120 receives a second touch signal, the menu controlling program 131 executes a currently selected function on the electronic apparatus 100.

In the present embodiment, the menu controlling program 131 recognizes detection of the first touch signal and the second touch signal by the touch device 120 through the I/O controller 125. Specifically, when receiving the first touch signal or the second touch signal, the touch device 120 transmits information related to the above-described signals to the I/O controller 125, and the I/O controller 125 transmits the information to the menu controlling program 131. Accordingly, the menu controlling program 131 executes the corresponding operation on the electronic apparatus 100 in response to the user's touch on the touch device 120. In the present embodiment, the I/O controller 125, for example, is an embedded controller.

It should be noted that, the user is able to manage and set the contents of the touch menu by themselves through the setting interface 133 provided by the menu controlling module 130. When the setting interface 133 receives an item management signal, the setting interface 133 adds, deletes, or modifies the items of the touch menu according to information inputted by the user. When the setting interface 133 receives a function management signal, the setting interface 133 modifies the functions corresponding to the items according to information inputted by the user. Accordingly, the user is able to set the number of the items of the touch menu and the functions corresponding to the items through the setting interface 133.

In the electronic apparatus 100, the functions provided by the touch device 120 are not simply limited to cursor control or object selection. Instead, the touch device 120 is correspondingly and sequentially selected one of the functions through the menu controlling program 131. Accordingly, the user simply requires a touch device 120 to accomplish adjusting the hardware device of the electronic apparatus 100 or to start a specific program.

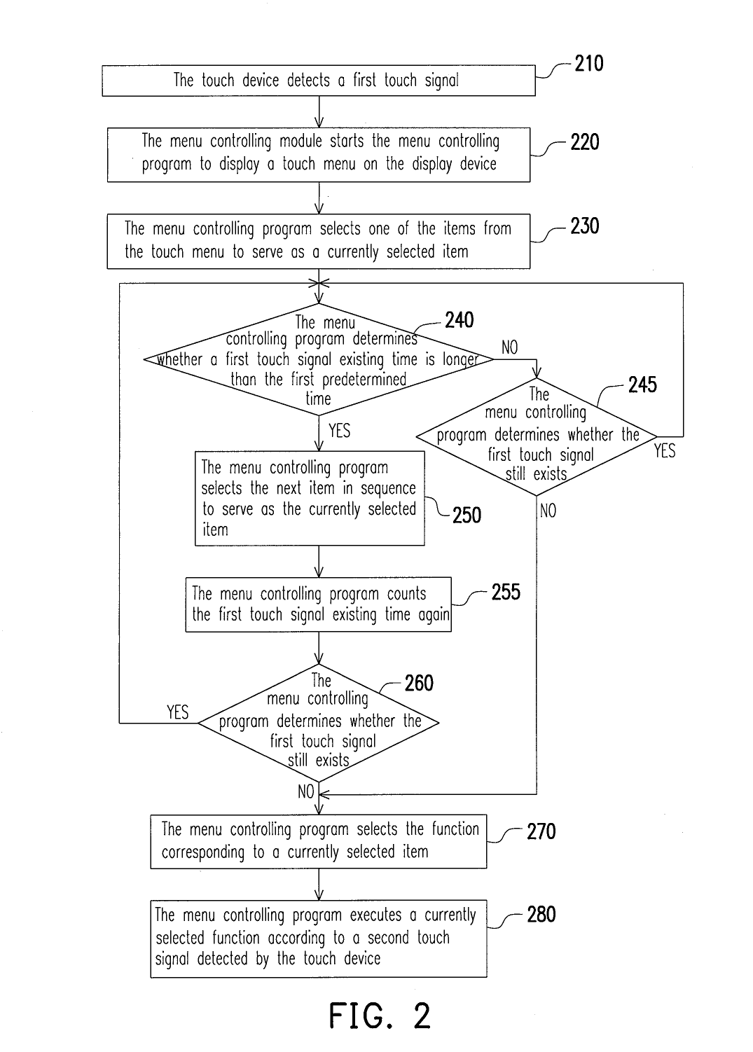

In order to further describe the operation of the electronic apparatus 100 in detail, another embodiment will be illustrated as follows to describe the invention. FIG. 2 is a flowchart of a touch menu control method according to an embodiment consistent with the invention. Referring to FIG. 1 and FIG. 2, first of all, when the user touches the touch device 120 with fingers or input tools, as shown in step 210, the touch device 120 detects a first touch signal from the user.

Next, in step 220, the menu controlling module 130 immediately starts the menu controlling program 131, and a touch menu is displayed on the display device 110 by the menu controlling program 131. In the present embodiment, the touch menu has a plurality of items, and each of the items corresponds to a different function. For example, the function corresponding to the item is starting functions of programs or adjusting functions of all types of hardware devices of the electronic apparatus 100, such as the display device, the sound broadcasting device (not shown), and the network device (not shown).

Next, the menu controlling program 131 changes the item to be selected. That is, a currently selected item is changed to the next item within the touch menu, so to sequentially select one of the items every first predetermined time, such as 0.5˜1 second, while the first touch signal exists. Then, when the first touch signal is interrupted, the menu controlling program 131 selects the function corresponding to the currently selected item. The first predetermined time can be set by the user through the setting interface 133. That is, when the setting interface receives a time management signal, the setting interface 133 adjusts the period of the first predetermined time according to information inputted by the user. However, in one embodiment, the first predetermined time is not shorter than 0.5 second.

In order to finish the above-described operation, as shown in step 230, after the menu controlling program 131 has been started and the display device has displayed the touch menu, the menu controlling program 131 selects one of the items from the touch menu to serve as the currently selected item. In the present embodiment, after the menu controlling program 131 has been started, the currently selected item which is immediately selected may be a predetermined item or the item corresponding to the function which was last executed.

Thereafter, as shown in step 240, the menu controlling program 131 determines whether a first touch signal existing time is longer than the first predetermined time. If the first touch signal existing time is longer than the first predetermined time, as shown in step 250, the menu controlling program 131 selects the next item in sequence to serve as the currently selected item. Next, as shown in step 255, the menu controlling program 131 counts the first touch signal existing time again. Moreover, in step 260, the menu controlling program 131 determines whether the first touch signal still exists. If the first touch signal still exists, it means that the user is continuously touching the touch device 120. Accordingly, as shown in step 240, the menu controlling program 131 determines whether the first touch signal existing time is longer than the first predetermined time again.

However, in step 240, if the menu controlling program 131 determines that the first touch signal existing time is shorter than the first predetermined time, the menu controlling program 131 moreover determines whether the first touch signal still exists, as shown in step 245. If the first touch signal still exists, it means that the user has not yet moved the fingers or input tools away from the touch device 120. Accordingly, the flow of the control method in the present embodiment will return to step 240, and the menu controlling program 131 determines whether the first touch signal existing time is longer than the first predetermined time again.

Before the first touch signal is interrupted, the menu controlling program 131 repeats the above-described operation, and sequentially selects one of the items every first predetermined time. In one embodiment, when selecting one of the items, the menu controlling program 131 further marks the items which were previously selected, i.e. the formerly selected items, in the touch menu, and thus the users is able to check the formerly selected items in the touch menu through the display device 110.

However, once the first touch signal is interrupted, it means that the user moves his or her fingers or input tools away from the touch device 120. At this moment, as shown in step 270, the menu controlling program 131 selects the function corresponding to a currently selected item. In the present embodiment, it is required that the I/O controller 125 adjusts the hardware device or starts the program. Accordingly, after selecting the function, the menu controlling program 131 also informs the I/O controller 125 that a currently selected function corresponding to the currently selected item. Finally, as shown in step 280, when the touch device 120 detects a second touch signal form the user, the menu controlling program 131 executes the currently selected function according to the second touch signal.

For example, when the currently selected function is a starting function, the menu controlling program 131 informs the I/O controller 125 to transmit a starting signal to start a program corresponding to the currently selected item. When the currently selected function is an adjusting function, the menu controlling program 131 informs the I/O controller 125 to execute an incremental adjustment on an operation of a hardware device corresponding to the currently selected item. Specifically, the I/O controller 125 outputs a corresponding adjustment signal, such as a scan code or a hardware signal, so as to execute the incremental adjustment on the operation of the hardware device according to directionality of the second touch signal and the type of the hardware device corresponding to the currently selected item.

In one embodiment, if the hardware device corresponding to the currently selected item is the display device 110 of the electronic apparatus 100, the function corresponding to the currently selected item is the function of adjusting brightness of the display device 110. Accordingly, the I/O controller 125 outputs the corresponding adjustment signal according to the directionality of the second touch signal to adjust the brightness of the display device 110.

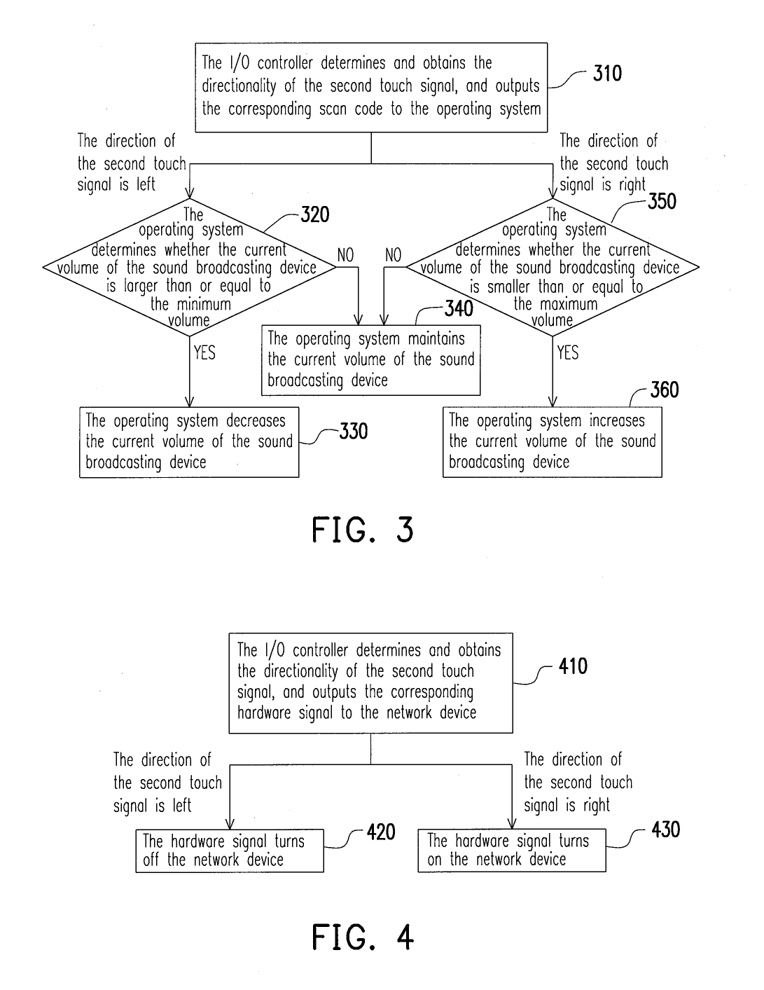

In another embodiment, if the hardware device corresponding to the currently selected item is the sound broadcasting device (not shown) of the electronic apparatus 100, the function corresponding to the currently selected item is the function of adjusting the volume of the sound broadcasting device. Accordingly, as shown in FIG. 3, when the user slide his or her fingers or input tools on the touch device 120, the second touch signal is existing, and the I/O controller 125 determines and obtains the directionality of the second touch signal, and further outputs the corresponding scan code to the operating system of the electronic apparatus 100 (step 310) to inform the operating system to adjust the volume of the sound broadcasting device. When receiving the scan code representing that the direction of the second touch signal is left, the operating system determines whether the current volume of the sound broadcasting device is larger than or equal to the minimum volume (step 320). If the current volume is larger than or equal to the minimum volume, the operating system decreases the current volume of the sound broadcasting device (step 330). If the current volume is smaller than the minimum volume, the operating system maintains the current volume of the sound broadcasting device (step 340). However, when receiving the scan code representing that the direction of the second touch signal is right, the operating system determines whether the current volume of the sound broadcasting device is smaller than or equal to the maximum volume (step 350). If the current volume is smaller than or equal to the maximum volume, the operating system increases the current volume of the sound broadcasting device (step 360). If the current volume is larger than the maximum volume, the operating system maintains the current volume of the sound broadcasting device (step 340).

In another embodiment, if the hardware device corresponding to the currently selected item is the network device of the electronic apparatus 100, such as a cable network device or a wireless network device, the I/O controller 125 control the network device to be turned on or turned off according to the directionality of the second touch signal. As shown in FIG. 4, when the user slides his or her fingers or input tools on the touch device 120, the second touch signal is existed, and the I/O controller 125 determines and obtains the directionality of the second touch signal and outputs the corresponding hardware signal, such as a voltage signal, to the network device (step 410). Accordingly, the I/O controller 125 directly informs the network device. If the direction of the second touch signal is left, the hardware signal outputted by the I/O controller 125 thus turns off the network device (step 420). However, if the direction of the second touch signal is right, the hardware signal outputted by the I/O controller 125 thus turns on the network device (step 430).

In the above-described embodiment, when the I/O controller 125 executes the incremental adjustment on the operation of the hardware device, the I/O controller 125 also informs the menu controlling program 131 of a degree of the incremental adjustment on the display device 110 according to the directionality of the second touch signal. Accordingly, the user is able to check the status of the incremental adjustment in any time.

It should be noted that, in the above-described embodiments, the corresponding relationship between the directionality of the second touch signal and the adjusting operation is simply an exemplary description for convenience, and it does not limit the scope of the invention.

As described above, the user is able to start the menu controlling program 131 through the touch device 120, and after being started, the menu controlling program 131 sequentially selects one of the items while the user touches the touch device 120 continuously. When the user moves his or her fingers or input tools away from the touch device 120, the menu controlling program 131 selects the functions to be executed. When the user touches the touch device 120 again, the currently selected function is executed on the electronic apparatus 100. Accordingly, the functions of the same touch device 120 can be increased, and the touch device 120 can replace a plurality of original hotkeys. Therefore, the cost of the hardware is reduced.

In following embodiments, it is assumed that the touch menu includes the items A, B, and C in sequence, and the items A, B, and C respectively correspond to the function of adjusting the brightness of the display device 110 of the electronic apparatus 100, the function of adjusting the volume of the sound broadcasting device of the electronic apparatus 100, and the function of turning on or turning off the wireless network device of the electronic apparatus 100.

When the user touches the touch device 120 of the electronic apparatus 100 first, the menu controlling program 131 is started and displays the touch menu on the display device 110. Meanwhile, the menu controlling program 131 also selects the item, such as the item A, corresponding to the function which was last executed to serve as the currently selected item.

Next, if the period during which the user continuously touches the touch device 120 is longer than the first predetermined time, the menu controlling program 131 selects the next item, such as the item B, to serve as the currently selected item in sequence. Thereafter, the operation is similar to that described above. In other words, when the user continuously presses the touch device 120, the menu controlling program 131 uses the first predetermined period as the time interval, and repeats the order of the items A, B, and C to select one of them to serve as the currently selected item.

If the user stops touching the touch device 120, and the item selected as the currently selected item is the item C, the menu controlling program 131 informs the I/O controller 125 to prepare for executing the function of turning on or turning off the wireless network device. Thereafter, when the touch device 120 receives the touch signal by the user again, the I/O controller 125 outputs the corresponding hardware signal to the wireless network device according to the directionality of the touch signal and the type of the wireless network device, and the I/O controller 125 turns on or turn off the network function of the wireless network device.

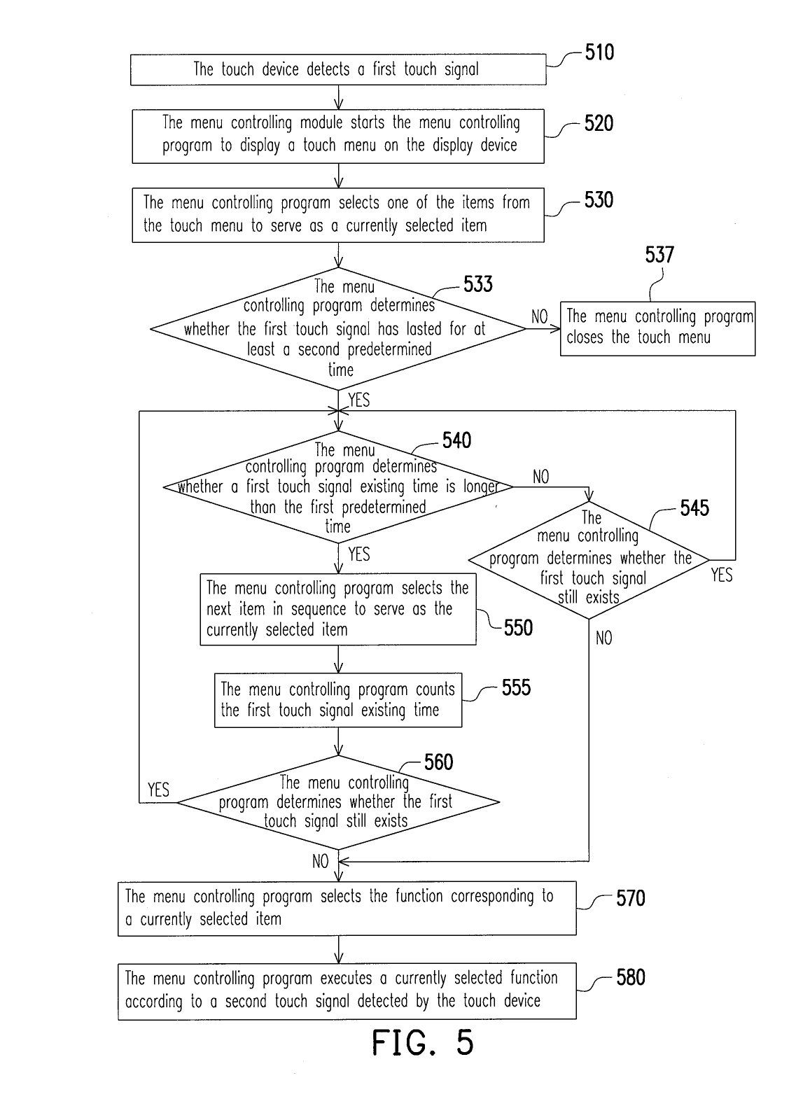

FIG. 5 is a flowchart of a touch menu control method according to an embodiment of the invention. In the present embodiment, steps 510 to 530 are similar to steps 210 to 230 in FIG. 2. When the user first touches the touch device (the touch device detects a first touch signal) to start the menu controlling program, the menu controlling program displays the touch menu on the display device, and selects one of the items in the touch menu to serve as the currently selected item. Next, in step 533, the menu controlling program determines whether the first touch signal has lasted for at least a second predetermined time. If the first touch signal is interrupted before the second predetermined time over, the menu controlling program closes the touch menu, as shown in step 537. However, when the period during which the user continuously touches the touch device becomes equal to the second predetermined time, the menu controlling program starts to sequentially select one of the items. That is, the period during which the first touch signal continuously exists has to be longer than the second predetermined time for the menu controlling program to start sequentially selecting one of the items at intervals equal to the first predetermined time. In other words, the second predetermined time is the threshold period for sequentially selecting one of the items. Next, since steps 540 to 580 are similar to or are the same as steps 240 to 280 in FIG. 2, they will not be described again herein.

In the present embodiment, the second predetermined time is longer than the first predetermined time. Similarly, both the first predetermined time and the second predetermined time are capable of being set by the user through the setting interface 133. When the setting interface 133 receives the time management signal, the setting interface 133 adjusts the period of the first and the second predetermined times according to information inputted by the user.

To sum up, in the electronic apparatus and the touch menu control method thereof provided in the embodiments consistent with the invention, when the user touches the touch device, a menu controlling program is started, and the menu controlling program sequentially selects one of the items in the touch menu according to the user's touch. When the user stops touching the touch device, the function to be executed is selected according to the currently selected item. Accordingly, when the user touches the touch device again, the menu controlling program is configured to execute the currently selected function according to the user's touch. As a result, the touch device of the electronic apparatus is capable of replacing the plurality of hotkeys, and further, the cost of the hardware is reduced. The user is also able to modify the content related to the touch menu according to the user's habits, so that the operation of the electronic apparatus is more flexible.

Although the invention has been described with reference to the above embodiments, it is apparent to one of the ordinary skill in the art that modifications to the described embodiments may be made without departing from the spirit of the invention. Accordingly, the scope of the invention will be defined by the attached claims not by the above detailed descriptions.

What is claimed is:

1. A touch menu control method of an electronic apparatus, wherein the electronic apparatus has a touch device and a display device, the control method comprising:
displaying a touch menu on the display device when the touch device detects a first touch signal, wherein the touch menu comprises a plurality of items, and each of the items corresponds to a function;
while the first touch signal exists, sequentially selecting one of the items every first predetermined time;
when the first touch signal is interrupted, selecting the function corresponding to a currently selected item; and
executing a currently selected function according to a second touch signal detected by the touch device.

2. The touch menu control method as claimed in claim 1, wherein the currently selected item is the item corresponding to the function which was last executed.

3. The touch menu control method as claimed in claim 1, wherein the step of sequentially selecting one of the items every first predetermined time comprises:
determining whether a first touch signal existing time is longer than the first predetermined time;
if the first touch signal existing time is longer than the first predetermined time, selecting the next item in sequence to serve as the currently selected item, and counting the first touch signal existing time again;
determining whether the first touch signal still exists; and
if the first touch signal still exists, repeating the above-described steps until the first touch signal is interrupted.

4. The touch menu control method as claimed in claim 3, wherein after the step of determining whether the first touch signal existing time is longer than the first predetermined time, the step of sequentially selecting one of the items every first predetermined time further comprises:
if the first touch signal existing time is shorter than the first predetermined time, determining whether the first touch signal still exists; and
if the first touch signal still exists, again determining whether the first touch signal existing time is longer than the first predetermined time.

5. The touch menu control method as claimed in claim 1, after the step of displaying the touch menu on the display device when the touch device detects the first touch signal, the control method further comprising:
when the first touch signal has lasted for at least a second predetermined time, selecting the next item in sequence to serve as the currently selected item, wherein the second predetermined time is longer than the first predetermined time.

6. The touch menu control method as claimed in claim 1, wherein the step of sequentially selecting one of the items every first predetermined time further comprises:
marking the currently selected item in the touch menu.

7. The touch menu control method as claimed in claim 1, wherein the step of executing the currently selected function comprises:
if the currently selected item corresponds to an adjusting function, executing an incremental adjustment on an operation of a hardware device corresponding to the currently selected item according to directionality of the second touch signal; and
if the currently selected item corresponds to a starting function, starting a program corresponding to the currently selected item.

8. The touch menu control method as claimed in claim 7, wherein the step of executing the incremental adjustment further comprises:
displaying a degree of the incremental adjustment on the display device.

9. An electronic apparatus, comprising:
a display device;
a touch device configured to detect a first touch signal; and
a menu controlling module coupled to the display device and the touch device, wherein:
the menu controlling module is configured to start a menu controlling program to display a touch menu on the display device when the touch device detects a first touch signal, wherein the touch menu comprises a plurality of items, and each of the items corresponds to a function;
the menu controlling program is configured to sequentially select one of the items every first predetermined time while the first touch signal exists;
the menu controlling program is configured to select the function corresponding to a currently selected item when the first touch signal is interrupted; and
the menu controlling program is configured to execute a currently selected function when a second touch signal is detected by the touch device.

10. The electronic apparatus as claimed in claim 9, further comprising:
an input and output controller (I/O controller) coupled between the touch device and the menu controlling module, wherein the menu controlling program recognizes detection of the first touch signal and the second touch signal by the touch device through the I/O controller.

11. The electronic apparatus as claimed in claim 10, wherein after the menu controlling module starts the menu controlling program to display the touch menu on the display device, the menu controlling program selects one of the items to serve as the currently selected item.

12. The electronic apparatus as claimed in claim 11, wherein if the currently selected function is an adjusting function, the menu controlling program informs the I/O controller to execute an incremental adjustment on an operation of a hardware device corresponding to the currently selected item.

13. The electronic apparatus as claimed in claim 12, wherein the I/O controller outputs an adjustment signal to execute the incremental adjustment on the operation of the hardware device corresponding to the currently selected item according to directionality of the second touch signal and a type of the hardware device.

14. The electronic apparatus as claimed in claim 13, wherein the I/O controller informs the menu controlling program of a degree of the incremental adjustment, so as to display the degree of adjustment on the display device.

15. The electronic apparatus as claimed in claim 11, wherein if the currently selected function is a starting function, the menu controlling program informs the I/O controller to output a starting signal to start a program corresponding to the currently selected item.

16. The electronic apparatus as claimed in claim 11, wherein the menu controlling module further comprises:
a setting interface configured to add, delete, or modify the items of the touch menu when the setting interface receives an item management signal.

17. The electronic apparatus as claimed in claim 16, wherein the setting interface is further configured to modify the functions corresponding to the items when the setting interface receives a function management signal.

18. The electronic apparatus as claimed in claim 16, wherein the setting interface is configured to adjust the first predetermined time and a second predetermined time when the setting interface receives a time management signal.
